(19) United States
(12) Patent Application Publication
(10) Pub. No.: US 2026/0008317 A1
(43) Pub. Date: Jan. 8, 2026

(54) Thermal Management System for Vehicle

(71) Applicant: Illinois Tool Works Inc., Glenview, IL (US)

(72) Inventor: Michael Henker, Shanghai (CN)

(21) Appl. No.: 19/259,867

(22) Filed: Jul. 3, 2025

(30) Foreign Application Priority Data
Jul. 4, 2024 (CN) 202410897868.X

(51) Int. Cl. B60H 1/00

(52) U.S. Cl. CPC B60H 1/00421; B60H 1/00885

(57) ABSTRACT

A thermal management system for a vehicle having a first flow channel, a second flow channel, a first pump device, a second pump device, a single driving device, and a clutch device. The first pump device is fluidly connected to the first flow channel and the second pump device is fluidly connected to the second flow channel. The driving device is connected to the first pump device to drive the first pump device. The clutch device is connected between the driving device and the second pump device and is configured to connect or disconnect the driving device and the second pump device to selectively allow the driving device to drive the second pump device, to selectively convey fluid through the second flow channel. The single driving device includes a single motor. This thermal management system increases flexibility and efficiency of fluid flow control while reducing cost, size, and weight. The present disclosure also uses the first pump device to drive the clutch device to allow the driving device to drive the second pump device, thereby also saving cost for the clutch device.

### RELATED APPLICATION

The present application claims the benefit of Chinese Patent Application Nos. 202410897868.X, filed Jul. 4, 2024, each titled “Thermal Management System for Vehicle,” the contents of which are hereby incorporated by reference.

### TECHNICAL FIELD

The present disclosure relates to a thermal management system, and in particular to a thermal management system for a vehicle.

### BACKGROUND

Thermal management systems for vehicles are used to control driving motors, air conditioners, batteries and other components of the vehicles at a required temperature for the safety, comfort, energy efficiency, economy and durability of the vehicles. The vehicles include new energy vehicles (NEVs), such as battery electric vehicles (BEVs), plug-in hybrid electric vehicles (PHEVs), fuel cell electric vehicles (FCEVs) and hybrid electric vehicles (HEVs), and conventional internal combustion engine (ICE) vehicles, such as fuel vehicles.

### SUMMARY OF THE DISCLOSURE

The present disclosure relates generally to a thermal management system, substantially as illustrated by and described in connection with at least one of the figures, as set forth more completely in the claims.

### BRIEF DESCRIPTION OF THE DRAWINGS

The foregoing and other objects, features, and advantages of the devices, systems, and methods described herein will be apparent from the following description of particular examples thereof, as illustrated in the accompanying figures, where like or similar reference numbers refer to like or similar structures. The figures are not necessarily to scale, emphasis instead being placed upon illustrating the principles of the devices, systems, and methods described herein.

FIG. 1 shows a block diagram structure of a thermal management system for a vehicle according to an embodiment of the present disclosure.

FIG. 2 shows a block diagram structure of an embodiment of a clutch device shown in FIG. 1.

FIG. 3 shows a block diagram of a thermal management method for a thermal management system according to an embodiment of the present disclosure.

### DETAILED DESCRIPTION

References to items in the singular should be understood to include items in the plural, and vice versa, unless explicitly stated otherwise or clear from the text. Grammatical conjunctions are intended to express any and all disjunctive and conjunctive combinations of conjoined clauses, sentences, words, and the like, unless otherwise stated or clear from the context. Recitation of ranges of values herein are not intended to be limiting, referring instead individually to any and all values falling within and/or including the range, unless otherwise indicated herein, and each separate value within such a range is incorporated into the specification as if it were individually recited herein. In the following description, it is understood that terms such as “first,” “second,” “top,” “bottom,” “side,” “front,” “back,” and the like are words of convenience and are not to be construed as limiting terms. For example, while in some examples a first side is located adjacent or near a second side, the terms “first side” and “second side” do not imply any specific order in which the sides are ordered.

The terms “about,” “approximately,” “substantially,” or the like, when accompanying a numerical value, are to be construed as indicating a deviation as would be appreciated by one of ordinary skill in the art to operate satisfactorily for an intended purpose. Ranges of values and/or numeric values are provided herein as examples only, and do not constitute a limitation on the scope of the disclosure. The use of any and all examples, or exemplary language (“e.g.,” “such as,” or the like) provided herein, is intended merely to better illuminate the disclosed examples and does not pose a limitation on the scope of the disclosure. The terms “e.g.,” and “for example” set off lists of one or more non-limiting examples, instances, or illustrations. No language in the specification should be construed as indicating any unclaimed element as essential to the practice of the disclosed examples.

The term “and/or” means any one or more of the items in the list joined by “and/or.” As an example, “x and/or y” means any element of the three-element set {(x), (y), (x, y)}. In other words, “x and/or y” means “one or both of x and y”. As another example, “x, y, and/or z” means any element of the seven-element set {(x), (y), (z), (x, y), (x, z), (y, z), (x, y, z)}. In other words, “x, y, and/or z” means “one or more of x, y, and z.”

In the thermal management system for a vehicle, electric pumps (e.g., electronic water pumps) are used to circulate the fluid through one or more components of the vehicle. The electric pump is driven by a driving unit, which includes a motor and an associated electronic device. The electric pump controls the flow rate of the fluid in the heat transfer loops of the thermal management system, and the different flow rates of the fluid carry away or supply heat to bring each component of the thermal management system to a required temperature. In existing thermal management systems, a plurality of electric pumps is used to circulate fluid through one or more components of the vehicle. Each pump operates independently and is driven by a corresponding drive unit comprising a motor and associated electronics.

In the present disclosure, the use of a single driving device to drive a plurality of pump devices enables increased efficiency and reduced cost, size and weight, as one or more driving devices (including motors and associated electronic devices) can be saved. In an embodiment, a single driving device is used for driving a first pump device and a second pump device. The single driving device includes a single motor and associated electronic devices. The driving device is connected to the first pump device to drive the first pump device. The driving device is also connected to the second pump device via a clutch device. The clutch device is configured to connect or disconnect the driving device and the second pump device to selectively allow the driving device to drive the second pump device. In other embodiments, a single driving device is used to drive more pump devices. The thermal management system of the present disclosure is capable of operating in the pump operating modes as follows: a single driving device is used to drive only the first pump device, or to drive the first pump device and the second pump device to provide the most efficient/best way of operation and allow multiple parallel and/or series connections of the heat transfer loops and flow rates of the fluid, to cool or heat corresponding components in the heat transfer loops to bring these components to a required temperature. Thus, the thermal management system of the present disclosure is capable of providing a greater variety of fluid flow controls, thereby increasing the flexibility and efficiency of the system. That is, the thermal management system of the present disclosure increases the flexibility and efficiency of fluid flow control of the system while reducing cost, size and weight.

In addition, the present disclosure also can use a first pump device to drive a clutch device, to cause the driving device to drive a second pump device. Such a configuration of the thermal management system of the present disclosure enables further cost savings, because the first pump device acts as an actuator for the clutch device 104, and therefore no separate actuator is required for the clutch device. More specifically, the present disclosure provides a flow channel between the first pump device and the clutch device for conveying fluid that is to be pumped by the first pump device to the clutch device, and provides a valve in the flow channel for controlling whether fluid is pumped from the first pump device to the clutch device. The flowing fluid conveyed by the first pump device to the clutch device generates fluid pressure to actuate the clutch device to switch to an engaged state, thereby causing the second pump device to be driven by the driving device.

Specifically, according to a first aspect of the present disclosure, there is provided a thermal management system for a vehicle. The thermal management system comprises a first flow channel, a second flow channel, a first pump device, a second pump device, a single driving device and a clutch device. The first pump device is fluidly connected to the first flow channel, and the second pump device fluidly connected to the second flow channel. The driving device is connected to the first pump device to drive the first pump device. The clutch device is connected between the driving device and the second pump device and configured to connect or disconnect the driving device and the second pump device, to selectively allow the driving device to drive the second pump device.

According to the first aspect of the present disclosure, the single driving device comprises a single motor.

According to the first aspect of the present disclosure, the thermal management system further comprises a first thermal management valve device and a second thermal management valve device. The first flow channel fluidly connects the first thermal management valve device to the second thermal management valve device, and the second flow channel fluidly connects the first thermal management valve device to the second thermal management valve device. The clutch device is configured to selectively allow the driving device to drive the second pump device to selectively convey a fluid from the first thermal management valve device to the second thermal management valve device through the second flow channel.

According to the first aspect of the present disclosure, the clutch device is configured to connect the driving device to the second pump device on the basis of temperature of one or more components of the thermal management system and/or an ambient temperature.

According to the first aspect of the present disclosure, the clutch device is configured to switch between an engaged state and a disengaged state thereof according to whether the first pump device pumps the fluid to the clutch device, to connect or disconnect the driving device and the second pump device.

According to the first aspect of the present disclosure, the first thermal management valve device and the second thermal management valve device are respectively a first manifold valve and a second manifold valve.

According to the first aspect of the present disclosure, the thermal management system further comprises a third flow channel. The third flow channel is connected between the second thermal management valve device and the clutch device to convey the fluid that is to be pumped by the first pump device to the clutch device.

According to the first aspect of the present disclosure, the second manifold valve is configured to control, by switching flow channels thereof, whether the fluid pumped by the first pump device to the second manifold valve is conveyed to the clutch device.

According to the first aspect of the present disclosure, the thermal management system further comprises a fourth flow channel and a fifth flow channel. The fourth flow channel is connected between the first thermal management valve device and the second thermal management valve device to convey the fluid that is to be pumped by the first pump device to the clutch device. The fifth flow channel is connected between the first thermal management valve device and the clutch device to convey the fluid that is to be pumped by the first pump device to the clutch device.

According to the first aspect of the present disclosure, the second manifold valve is configured to convey the fluid, which is pumped by the first pump device to the second manifold valve, to the first manifold valve through a flow channel of the second manifold valve. The first manifold valve is configured to control, by switching flow channels thereof, whether the fluid pumped by the first pump device to the first manifold valve is conveyed to the clutch device.

According to the first aspect of the present disclosure, the first manifold valve and the second manifold valve are each configured to control, by switching the flow channels thereof, whether the fluid pumped by the first pump device is conveyed to the clutch device, to control the clutch device to switch between the engaged state and the disengaged state thereof, thereby connecting or disconnecting the driving device and the second pump device.

According to the first aspect of the present disclosure, the thermal management system is operated in a first pump device operating mode and a second pump device operating mode. In the first pump device operating mode, only the first pump device is activated. In the second pump device operating mode, the first pump device and the second pump device are activated.

According to the first aspect of the present disclosure, the first pump device is a main pump device configured to allow the fluid to flow at a high flow rate, and the second pump device is an auxiliary pump device configured as a supplement to the main pump device.

According to the first aspect of the present disclosure, the first flow channel and the second flow channel are each a part of a cooling circuit or a heating circuit in the thermal management system.

According to the first aspect of the present disclosure, the thermal management system further comprises an additional flow channel, an additional pump device and an additional clutch device. The additional flow channel fluidly connects the first thermal management valve device to the second thermal management valve device. The additional clutch device is connected between the driving device and the additional pump device and configured to connect or disconnect the driving device and the additional pump device to selectively allow the driving device to drive the additional pump device, to selectively convey the fluid from the first thermal management valve device to the second thermal management valve device through the additional flow channel.

According to the first aspect of the present disclosure, the first thermal management valve device and the second thermal management valve device are each configured to control, by switching flow channels thereof, whether the fluid pumped by the first pump device is conveyed to the additional clutch device, to control the additional clutch device to switch between an engaged state and a disengaged state thereof, thereby connecting or disconnecting the driving device and the additional pump device.

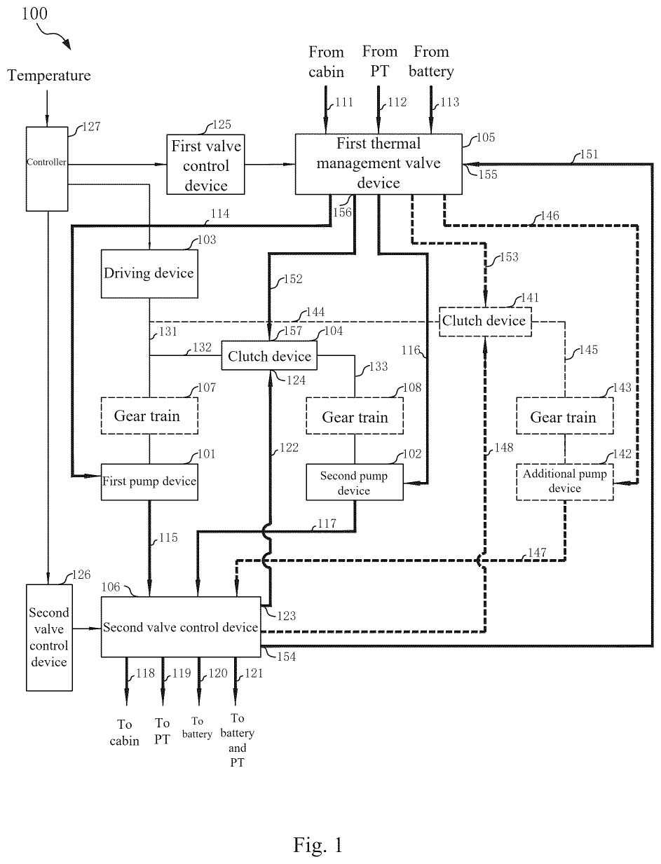

FIG. 1 shows a block diagram structure of a thermal management system 100 for a vehicle (not shown) according to an embodiment of the present disclosure.

As shown in FIG. 1, the thermal management system 100 includes a first thermal management valve device 105, a second thermal management valve device 106, a first flow channel 114, 115, a second flow channel 116, 117, a first pump device 101, a second pump device 102, a driving device 103 and a clutch device 104. The driving device 103 is a single driving device. The single driving device includes a single motor and an associated electronic device. The pump device includes a pump.

The first flow channel 114, 115 fluidly connects the first thermal management valve device 105 to the second thermal management valve device 106. The first flow channel 114, 115 is fluidly connected at its inlet to the first thermal management valve device 105 and at its outlet to the second thermal management valve device 106. The second flow channel 116, 117 fluidly connects the first thermal management valve device 105 to the second thermal management valve device 106. The second flow channel 116, 117 is fluidly connected at its inlet to the first thermal management valve device 105 and at its outlet to the second thermal management valve device 106.

The first thermal management valve device 105 is configured to convey a fluid flowing through one or more components of the thermal management system 100, such as a cabin, a power train (PT) and a battery, to the first flow channel 114, 115, or to the first flow channel 114, 115 and the second flow channel 116, 117. As shown in FIG. 1, in an embodiment, the fluid flows from the cabin to the first thermal management valve device 105 through a flow channel 111, the fluid flows from the power train (PT) to the first thermal management valve device 105 through a flow channel 112, and the fluid flows from the battery to the first thermal management valve device 105 through a flow channel 113.

The first pump device 101 is fluidly connected in the first flow channel 114, 115 and is configured to circulate the fluid through the first flow channel 114, 115. Reference signs 114, 115 denote two parts of the first flow channel, for example, an upstream flow channel and a downstream flow channel of the first pump device 101. The first pump device 101 is operated to convey the fluid flowing out of the first thermal management valve device 105 to the second thermal management valve device 106 through the first flow channel 114, 115. That is, the first pump device 101 is activated to convey the fluid from the first thermal management valve device 105 to the second thermal management valve device 106 through the first flow channel 114, 115.

The second pump device 102 is fluidly connected in the second flow channel 116, 117 and is configured to circulate the fluid through the second flow channel 116, 117. Reference signs 116, 117 denote two parts of the second flow channel, for example, an upstream flow channel and a downstream flow channel of the second pump device 102. The second pump device 102 is operated to convey the fluid flowing out of the first thermal management valve device 105 to the second thermal management valve device 106 through the second flow channel 116, 117. That is, the second pump device 102 is activated to convey the fluid from the first thermal management valve device 105 to the second thermal management valve device 106 through the second flow channel 116, 117.

The second thermal management valve device 106 is configured to convey the fluid flowing through the first flow channel 114, 115 and the second flow channel 116, 117 to one or more components of the thermal management system 100 where the fluid is required to arrive, such as the cabin, the power train (PT), the battery, etc. As shown in FIG. 1, in an embodiment, the fluid flows from the second thermal management valve device 106 to the cabin through a flow channel 118, the fluid flows from the second thermal management valve device 106 to the power train (PT) through a flow channel 119, the fluid flows from the second thermal management valve device 106 to the battery through a flow channel 120, and the fluid flows from the second thermal management valve device 106 to the battery and the power train (PT) through a flow channel 121. When the component at which the fluid arrives is the same as the component from which the fluid flows (from which the fluid flows to the first thermal management valve device 105), the fluid flows through the same component. In this case, the thermal management system 100 may be operated in a parallel mode, for example. When the component at which the fluid arrives is different from the component from which the fluid flows, the fluid flows through different components. In this case, the thermal management system 100 may be operated in a series mode, for example.

The driving device 103 is connected, for example mechanically, to the first pump device 101 for driving the first pump device 101. As shown in FIG. 1, the driving device 103 includes a driving device shaft 131 engaged with the first pump device 101. The driving device 103 is operated to rotate its driving device shaft 131. The driving device shaft 131 in turn drives the first pump device 101 to operate, thereby circulating the fluid through the first flow channel 114, 115. In other embodiments, the driving device 103 is connected to the first pump device 101 by other suitable means to drive the first pump device 101. In such an operating mode, the operation of the driving device 103 is controlled by a controller 127 to drive the first pump device 101 to operate, such that the fluid flowing through one or more components of the thermal management system 100 flows through the first thermal management valve device 105 and the first flow channel 114, 115 in sequence to arrive at the second thermal management valve device 106, and flows through the second thermal management valve device 106 to one or more components of the thermal management system 100 where the fluid is required to arrive.

The clutch device 104 is connected between the driving device 103 and the second pump device 102. The clutch device 104 is configured to connect or disconnect the driving device 103 and the second pump device 102 to selectively allow the driving device 103 to drive the second pump device 102 to selectively convey the fluid from the first thermal management valve device 105 to the second thermal management valve device 106 through the second flow channel 116, 117. The clutch device 104 is controlled to switch between an engaged state and a disengaged state to connect or disconnect the driving device 103 and the second pump device 102.

The clutch device 104 is connected to the driving device 103 via a driving engagement portion 132, in particular to the driving device shaft 131 of the driving device 103, and is connected to the second pump device 102 via a driven engagement portion 133. When the clutch device 104 is switched to the engaged state, the driving engagement portion 132 and the driven engagement portion 133 of the clutch device 104 are connected to each other such that the driving device 103 is connected to the second pump device 102, and the driving device 103 thus can drive the second pump device 102. In such an operating mode, the driving device 103 drives the first pump device 101 and the second pump device 102 to operate such that the fluid flowing through one or more components of the thermal management system 100 flows through the first thermal management valve device 105, flows through the first flow channel 114, 115 and the second flow channel 116, 117 to the second thermal management valve device 106, and flows through the second thermal management valve device 106 to one or more components of the thermal management system 100 where the fluid is required to arrive. When the clutch device 104 is switched to the disengaged state, the driving engagement portion 132 and the driven engagement portion 133 of the clutch device 104 are disengaged from each other such that the driving device 103 is disconnected from the second pump device 102 and cannot drive the second pump device 102. That is, the driving device 103 activates the first pump device 101 but does not activate the second pump device 102. The fluid thus flows from the first thermal management valve device 105 to the second thermal management valve device 106 through the first flow channel 114, 115 but not through the second flow channel 116, 117. In an embodiment, the clutch device 104 is a clutch.

The thermal management system for a battery electric vehicle (BEV) or a pure electric vehicle includes two main heat transfer loops. One of the heat transfer loops is a power train (PT) loop for circulating the fluid through a driving motor, a power electronic device, etc. of the thermal management system, to control the temperatures of these components. The other heat transfer loop is a battery loop for circulating the fluid through a battery of the thermal management system, such as a high-voltage battery, to control the temperature of the battery. The thermal management system for the pure electric vehicle further includes additional heat transfer loops, such as a cabin loop, for circulating the fluid through a cabin of the thermal management system to control the temperature of the cabin. In contrast to the pure electric vehicle, the thermal management system for a hybrid electric vehicle further includes, for example, an engine loop for circulating the fluid through an engine of the thermal management system, to control the temperature of the engine. The thermal management system for a fuel vehicle includes two main heat transfer loops. One of the heat transfer loops is a cabin loop for circulating the fluid through a cabin of the thermal management system to control the temperature of the cabin. The other heat transfer loop is an engine loop for circulating the fluid through an engine of the thermal management system, to control the temperature of the engine. In a fuel cell electric vehicle (FCEV), the thermal management system includes two main heat transfer loops. One of the heat transfer loops is configured to circulate the fluid through a fuel cell and a power train (PT) of the thermal management system, to control the temperatures of the fuel cell and the power train (PT). The other heat transfer loop is a battery loop for circulating the fluid through a battery of the thermal management system, to control the temperature of the battery.

In the thermal management system 100 of the present disclosure, by switching of the respective flow channels of the first thermal management valve device 105 and the second thermal management valve device 106 and by activation of the first pump device 101 and the second pump device 102, the required parallel and/or series connection of the heat transfer loops of the thermal management system 100 is achieved, thereby providing corresponding cooling or heating of the required components of the thermal management system, to bring these components to the required temperatures.

As shown in FIG. 1, the thermal management system 100 further includes the controller 127, a first valve control device 125, and a second valve control device 126. The controller 127 is configured to acquire a temperature and/or an ambient temperature of one or more components of the thermal management system 100 and process (e.g., calculate, or predict) the temperature to determine a connection scheme for the heat transfer loops of the thermal management system 100, to generate control signals on the basis of the connection scheme, and to output the control signals respectively to the driving device 103, the first valve control device 125 and the second valve control device 126. The connection scheme includes parallel and/or series connection and required flow rates of the heat transfer loops, cooling or heating of the individual components in the heat transfer loops, etc. The connection scheme further includes whether the second pump device 102 is required to be activated to selectively convey the fluid from the first thermal management valve device 105 to the second thermal management valve device 106 through the second flow channel 116, 117. Activating only the first pump device 101, or activating the first pump device 101 and the second pump device 102, may be used to achieve the series connection of the heat transfer loops. Generally, the parallel connection of the heat transfer loops can be achieved by activating the first pump device 101 and the second pump device 102.

In an embodiment, the controller 127 determines which components are required to be cooled/heated on the basis of the actual temperature and target temperature of one or more components of the thermal management system, to determine whether the second pump device 102 is required to be activated. The controller 127 determines what flow rate is required for each heat transfer loop on the basis of the actual temperature and target temperature of one or more components of the thermal management system or the ambient temperature, to determine whether the second pump device 102 is required to be activated. The controller 127 determines an operating mode required by the thermal management system on the basis of the actual temperature and target temperature of one or more components of the thermal management system or the ambient temperature, for example, a parallel or series mode, to determine whether the second pump device 102 is required to be activated.

The first valve control device 125 is operated on the basis of the received control signal to control the first thermal management valve device 105 to switch flow channels thereof to bring the fluid from one or more components of the thermal management system to the required flow channel, such as the first flow channel 114, 115, or the first flow channel 114, 115 and the second flow channel 116, 117, through a selected flow channel of the first thermal management valve device 105. In an embodiment, the first thermal management valve device 105 is activated by pressure. For example, the first valve control device 125 provides pressure to the first thermal management valve device 105, and the first thermal management valve device 105 switches the flow channels thereof in response to the pressure. In other embodiments, the first thermal management valve device 105 is activated by other suitable means to switch the flow channels thereof. The driving device 103 is operated on the basis of the received control signal to drive the first pump device 101 to convey the fluid from the first thermal management valve device 105 to the second thermal management valve device 106 through the first flow channel 114, 115. Moreover, the driving device 103 is operated to be connected to or disconnected from the second pump device 102 on the basis of the received control signal to selectively cause the driving device 103 to drive the second pump device 102, to selectively convey the fluid from the first thermal management valve device 105 to the second thermal management valve device 106 through the second flow channel 116, 117. The driving device 103 receives the control signal from the controller 127 to drive the first pump device 101, or to drive the first pump device 101 and the second pump device 102. In an embodiment, the driving device 103 includes a motor and an associated electronic device. The electronic device receives the control signal from the controller 127 to drive the motor to operate such that the motor drives the first pump device 101, or drives the first pump device 101 and the second pump device 102. In an embodiment, the first pump device 101 and the second pump device 102 are electronic water pumps. In an embodiment, the driving device 103 is a 48V driving device that includes a 48V motor and an associated electronic device.

The second valve control device 126 is operated on the basis of the received control signal to control the second thermal management valve device 106 to switch flow channels thereof to bring the fluid from the first flow channel 114, 115, or from the first flow channel 114, 115 and the second flow channel 116, 117, to the required one or more components of the thermal management system through a selected flow channel of the second thermal management valve device 106. In an embodiment, the second thermal management valve device 106 is activated by pressure. For example, the second valve control device 126 provides pressure to the second thermal management valve device 106, and the second thermal management valve device 106 switches the flow channels thereof in response to the pressure. In other embodiments, the second thermal management valve device 106 is activated by other suitable means to switch the flow channels thereof. In this way, the heat transfer loops of the thermal management system are connected according to the determined connection scheme and the respective components are cooled or heated so that these components reach the required temperatures.

The selected flow channels of the first thermal management valve device 105 and the second thermal management valve device 106 may allow the fluid to flow individually, or mix the fluid. In the series mode, the fluid of each heat transfer loop may be mixed in the flow channels of the first thermal management valve device 105 and the second thermal management valve device 106. In the parallel mode, the fluid of each heat transfer loop generally flows individually through the flow channels of the first thermal management valve device 105 and the second thermal management valve device 106. In an embodiment, the first thermal management valve device 105 and the second thermal management valve device 106 are a first manifold valve 105 and a second manifold valve 106, respectively. In another embodiment, the first thermal management valve device 105 and the second thermal management valve device 106 are each composed of a plurality of individual valves. The first flow channel 114, 115 and the second flow channel 116, 117 are each a part of a cooling circuit and/or a heating circuit in the thermal management system 100. The cooling circuit is used to cool one or more components of the thermal management system 100. The heating circuit is used to heat one or more components of the thermal management system 100.

The clutch device 104 is configured to connect the driving device 103 to the second pump device 102 on the basis of the temperature of one or more components of the thermal management system and/or the ambient temperature. During operation, the controller 127 is configured to determine, on the basis of the temperature of one or more components of the thermal management system 100 and/or the ambient temperature, a connection scheme for the heat transfer loops, to generate a control signal on the basis of the connection scheme, and to output the control signal to the clutch device 104. The connection scheme includes whether the second pump device 102 is required to be activated. The clutch device 104 is switched to its engaged state on the basis of the control signal, to connect the driving device 103 to the second pump device 102 to drive the second pump device 102.

In an embodiment, the clutch device 104 is controlled by hydraulic pressure to switch between the engaged state and the disengaged state to connect or disconnect the driving device 103 and the second pump device 102. The clutch device 104 is configured to switch between the engaged state and the disengaged state thereof according to whether the first pump device 101 pumps the fluid to the clutch device 104, to connect or disconnect the driving device 103 and the second pump device 102.

As shown in FIG. 1, the thermal management system 100 further includes a third flow channel 122 connected between a valve outlet 123 of the second thermal management valve device 106 and a fluid inlet 124 of the clutch device 104 to convey the fluid that is to be pumped by the first pump device 101 to the clutch device 104. The second thermal management valve device 106 is configured to control, by switching flow channels thereof, whether the fluid pumped by the first pump device 101 to the second thermal management valve device 106 is conveyed to the clutch device 104. Specifically, the controller 127 is configured to determine, on the basis of the temperature of one or more components of the thermal management system 100 and/or the ambient temperature, a connection scheme for the heat transfer loops. The connection scheme includes whether to open the valve outlet 123 of the second thermal management valve device 106, such that the fluid pumped by the first pump device 101 to the second thermal management valve device 106 is selectively conveyed to the clutch device 104. The controller 127 generates a control signal on the basis of the connection scheme and outputs the control signal to the second valve control device 126. The second valve control device 126 controls, on the basis of the received control signal, the second thermal management valve device 106 to switch the flow channels thereof to open the valve outlet 123, so that the first pump device 101 pumps the fluid from the first flow channel 115 to the clutch device 104 through the second thermal management valve device 106 and the third flow channel 122. The fluid flows from the fluid inlet 124 of the clutch device 104 to the clutch device 104 and generates a fluid pressure to drive the clutch device 104 to switch to the engaged state, to connect the driving device 103 to the second pump device 102. The second valve control device 126 further controls, on the basis of the received control signal, the second thermal management valve device 106 to switch the flow channels thereof to close the valve outlet 123, so that the fluid pumped by the first pump device 101 to the second thermal management valve device 106 cannot be conveyed to the clutch device 104. In this case, the clutch device 104 remains in the disengaged state to disconnect the driving device 103 from the second pump device 102.

As shown in FIG. 1, the thermal management system 100 further includes a fourth flow channel 151 connected between a valve outlet 154 of the second thermal management valve device 106 and a fluid inlet 155 of the first thermal management valve device 105 to convey the fluid that is to be pumped by the first pump device 101 to the first thermal management valve device 105. The thermal management system 100 further includes a fifth flow channel 152 connected between a valve outlet 156 of the first thermal management valve device 105 and a fluid inlet 157 of the clutch device 104 to convey the fluid that is to be pumped by the first pump device 101 to the clutch device 104. The second thermal management valve device 106 has its flow channels configured such that the valve outlet 154 is always open, so that the fluid pumped by the first pump device 101 can flow through the second thermal management valve device 106 and the fourth flow channel 151 to the first thermal management valve device 105. The first thermal management valve device 105 is configured to control, by switching the flow channels thereof, whether the fluid pumped by the first pump device 101 to the first thermal management valve device 105 is conveyed to the clutch device 104 through the fifth flow channel 152.

Specifically, the controller 127 is configured to determine, on the basis of the temperature of one or more components of the thermal management system 100 and/or the ambient temperature, a connection scheme for the heat transfer loops. In an embodiment, the connection scheme includes always opening the valve outlet 154 of the second thermal management valve device 106 and whether to open the valve outlet 156 of the first thermal management valve device 105. The controller 127 generates control signals on the basis of the connection scheme and outputs the control signals to the second valve control device 126 and the first valve control device 125. The second valve control device 126 controls the flow channels of the second thermal management valve device 106 on the basis of the received control signal to always open the valve outlet 154, so that the first pump device 101 pumps the fluid through the second thermal management valve device 106 to flow through the fourth flow channel 151 to the first thermal management valve device 105. The first valve control device 125 controls the first thermal management valve device 105 to switch the flow channels thereof on the basis of the received control signal to open the valve outlet 156, so that the fluid pumped from the first pump device 101 to the first thermal management valve device 105 is conveyed to the clutch device 104 through the fifth flow channel 152. The fluid flows from the fluid inlet 157 of the clutch device 104 to the clutch device 104 and generates a fluid pressure to drive the clutch device 104 to switch to the engaged state, to connect the driving device 103 to the second pump device 102. The first valve control device 125 further controls, on the basis of the received control signal, the first thermal management valve device 105 to switch the flow channels thereof to close the valve outlet 156, so that the fluid pumped by the first pump device 101 to the first thermal management valve device 105 cannot be conveyed to the clutch device 104. In this case, the first thermal management valve device 105 is used to control the clutch device 104 in the disengaged state. In an embodiment, the fluid inlets 124, 157 of the clutch device 104 are the same fluid inlet.

In a first embodiment, the second thermal management valve device 106 is configured to control, by switching the flow channels thereof, whether the fluid pumped by the first pump device 101 is conveyed to the clutch device 104 to control the clutch device 104 to switch between the engaged state and the disengaged state thereof, thereby selectively causing the driving device 103 to drive the second pump device 102. In a second embodiment, the first thermal management valve device 105 is configured to control, by switching the flow channels thereof, whether the fluid pumped by the first pump device 101 is conveyed to the clutch device 104 to control the clutch device 104 to switch between the engaged state and the disengaged state thereof, thereby selectively causing the driving device 103 to drive the second pump device 102.

In a third embodiment, the first thermal management valve device 105 and the second thermal management valve device 106 are each configured to control, by switching the flow channels thereof, whether the fluid pumped by the first pump device 101 is conveyed to the clutch device 104 to control the clutch device 104 to switch between the engaged state and the disengaged state thereof, thereby selectively causing the driving device 103 to drive the second pump device 102. The first thermal management valve device 105 and the second thermal management valve device 106 may also be used to adjust the flow rate of the fluid by controlling their opening degrees. When the same thermal management valve device is used to adjust the flow rate of the fluid and control the clutch device 104, small interference with the pressure of the fluid supplied to the clutch device 104 may occur, thereby affecting the accuracy and stability of control over the clutch device 104. In this embodiment, both the first thermal management valve device 105 and the second thermal management valve device 106 can control the clutch device 104. Therefore, when one of the first thermal management valve device 105 and the second thermal management valve device 106 is required to adjust the flow rate of the fluid by controlling its opening degree, the clutch device 104 can still be controlled by the other of the first thermal management valve device 105 and the second thermal management valve device 106, so that the pressure of the fluid supplied to the clutch device 104 is kept stable, and the control over the clutch device 104 is thus accurate and stable. The clutch device 104 of the present disclosure may be driven by other suitable means, such as by electrical power or by means of a mechanical device, to switch between the engaged state and the disengaged state, thereby connecting or disconnecting the driving device 103 and the second pump device 102. In an embodiment, the thermal management system 100 includes a power supply (not shown) for driving the clutch device 104. When the power supply supplies electrical power to the clutch device 104, the clutch device 104 can be driven to the engaged state, to connect the driving device 103 to the second pump device 102. When the power supply does not supply electrical power to the clutch device 104, the clutch device 104 is in the disengaged state, for disconnecting the driving device 103 from the second pump device 102. In another embodiment, the thermal management system 100 includes a mechanical device (not shown) connected to the clutch device 104 and an actuator (not shown) for actuating the mechanical device. The actuator is operated to move the mechanical device, which in turn actuates the clutch device 104 to switch to the engaged state, to connect the driving device 103 to the second pump device 102. When the actuator is not operated, the clutch device 104 is not actuated to remain in the disengaged state, for disconnecting the driving device 103 from the second pump device 102.

In an embodiment, the first pump device 101 is a main pump device for causing the fluid to flow through the first flow channel 114, 115 at a high flow rate. The second pump device 102 is an auxiliary pump device configured as a supplement to the main pump device. In an embodiment, the auxiliary pump device supplements the main pump device by conveying the fluid with greater efficiency at a specific operating point. In another embodiment, the auxiliary pump device supplements the main pump device by increasing the capacity of a main pump.

Optionally, the thermal management system 100 includes gear trains 107, 108. The gear train 107 is connected between the driving device 103 and the first pump device 101 and adjusts the power supplied by the driving device 103 to the first pump device 101 to control an operating speed of the first pump device 101 such that the fluid flows through the first flow channel 114, 115 at a required flow rate. The gear train 108 is connected between the clutch device 104 and the second pump device 102 and, when the clutch device 104 is switched to the engaged state, adjusts the power supplied by the driving device 103 to the second pump device 102 via the clutch device 104 to control an operating speed of the second pump device 102 such that the fluid flows through the second flow channel 116, 117 at a required flow rate.

As shown in FIG. 1, the thermal management system 100 further includes an additional flow channel 146, 147, an additional pump device 142, and an additional clutch device 141. The additional flow channel 146, 147 fluidly connects the first thermal management valve device 105 to the second thermal management valve device 106. The additional clutch device 141 is connected between the driving device 103 and the additional pump device 142 and configured to connect or disconnect the driving device 103 and the additional pump device 142 to selectively allow the driving device 103 to drive the additional pump device 142, to selectively convey the fluid from the first thermal management valve device 105 to the second thermal management valve device 106 through the additional flow channel 146, 147. Specifically, the additional clutch device 141 is mechanically connected to the driving device 103 via a connecting line 144 and to the additional pump device 142 via a connecting line 145. Optionally, the thermal management system 100 further includes an additional gear train 143. The gear train 143 is connected between the additional clutch device 141 and the additional pump device 142 and, when the additional clutch device 141 is switched to an engaged state, adjusts the power supplied by the driving device 103 to the additional pump device 142 via the additional clutch device 141 to control an operating speed of the additional pump device 142 such that the fluid flows through the additional flow channel 146,147 at a required flow rate.

The thermal management system 100 further includes an additional flow channel 148 arranged between the second thermal management valve device 106 and the additional clutch device 141. The second thermal management valve device 106 is configured to control, by switching the flow channels thereof, whether the fluid pumped by the first pump device 101 is conveyed to the additional clutch device 141 to cause the additional clutch device 141 to be switched between the engaged state and the disengaged state thereof, thereby selectively causing the driving device 103 to drive the additional clutch device 141. The thermal management system 100 further includes an additional flow channel 153 arranged between the first thermal management valve device 105 and the additional clutch device 141. The first thermal management valve device 105 is configured to control, by switching the flow channels thereof, whether the fluid pumped by the first pump device 101 is conveyed to the additional clutch device 141 to control the additional clutch device 141 to switch between the engaged state and the disengaged state thereof, thereby selectively causing the driving device 103 to drive the additional clutch device 141. Similar to the aforementioned control over the clutch device 104 by the first thermal management valve device 105 and the second thermal management valve device 106, for the additional clutch device 141, at least one of the first thermal management valve device 105 and the second thermal management valve device 106 is configured to control, by switching the flow channels thereof, whether the fluid pumped by the first pump device 101 is conveyed to the additional clutch device 141, thereby selectively causing the driving device 103 to drive the additional clutch device 141. When both the first thermal management valve device 105 and the second thermal management valve device 106 can control the additional clutch device 141, the control over the additional clutch device 141 can be made more accurate and stable. In contrast to an implementation in which only one of the first thermal management valve device 105 and the second thermal management valve device 106 can control a plurality of clutch devices, the implementation in which both the first thermal management valve device 105 and the second thermal management valve device 106 can control a plurality of clutch devices can make the system's control simpler and reduces system costs. Since each of the first thermal management valve device 105 and the second thermal management valve device 106 is configured to control a smaller number of clutch devices, including controlling only one clutch device, it is possible to simplify the system's control over the clutch devices, and to reduce the size and cost of the thermal management valve devices and the control devices thereof (e.g., the valve control devices 125, 126).

In existing thermal management systems, a plurality of electric pumps are used to circulate the fluid through one or more components of the thermal management system. Each pump is operated independently and is driven by a corresponding driving unit. The driving unit includes a motor and an associated electronic device.

In the present disclosure, a single driving device 103 is used to drive at least two pump devices, for example, the first pump device 101, the second pump device 102 and the additional pump device 142, and some of the pump devices are selectively driven, for example, to achieve the required operating mode (parallel or series) of the thermal management system, the required flow rate control over the flow channels in the heat transfer loops, and the required heating or cooling of one or more components of the thermal management system to bring these components to the required temperatures.

In the present disclosure, the use of a single driving device with high power to drive a plurality of pump devices enables increased efficiency and reduced cost, size and weight, as more costly, large size and heavy weight components can be saved, such as driving devices (including motors and electronic devices). More specifically, the thermal management system of the present disclosure uses a single driving device, which includes a single motor and an associated electronic device, so that in the present disclosure, at least one or more driving devices (including motors and associated electronic devices) can be saved, thereby saving costs, and reducing the size and weight. Moreover, compared to a low-power driving device (e.g., a 12V driving device) for driving a single pump device, the high-power driving device (e.g., a 48V driving device) of the present disclosure can reduce current consumption with substantially no increase in cost.

Furthermore, in the present disclosure, the clutch device 104 is provided between the single driving device 103 and the second pump device 102 to connect or disconnect the driving device 103 and the second pump device 102 by operation of the clutch device 104 to selectively allow the driving device 103 to drive the second pump device 102 to selectively convey the fluid from the first thermal management valve device 105 to the second thermal management valve device 106 through the second flow channel 116, 117. In this way, the thermal management system of the present disclosure can provide more diverse fluid flow control options, for example, making more heat transfer loops connected in parallel or in series, and increasing the flexibility and efficiency of the system. That is, the present disclosure increases the flexibility and efficiency of fluid flow control of the thermal management system while reducing the cost, size and weight of the thermal management system.

In addition, in the present disclosure, the switching of the clutch device 104 between the engaged state and the disengaged state thereof is controlled by means of the first pump device 101, thereby connecting or disconnecting the driving device 103 and the second pump device 102 to selectively cause the driving device 103 to drive the second pump device 102. Such a configuration of the present disclosure enables further cost savings, because the first pump device 101 acts as an actuator for the clutch device 104, and therefore no separate actuator is required for the clutch device 104.

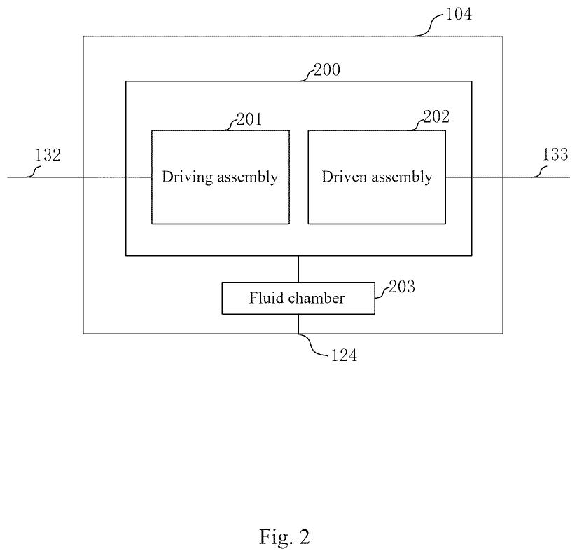

FIG. 2 shows a block diagram structure of an embodiment of the clutch device 104 shown in FIG. 1. As shown in FIG. 1, the clutch device 104 is connected between the driving device 103 and the second pump device 102. The clutch device 104 is configured to connect or disconnect the driving device 103 and the second pump device 102 to selectively allow the driving device 103 to drive the second pump device 102 to selectively convey the fluid from the first thermal management valve device 105 to the second thermal management valve device 106 through the second flow channel 116, 117. The clutch device 104 is configured to switch between an engaged state and a disengaged state to connect or disconnect the driving device 103 and the second pump device 102.

In an embodiment, the clutch device 104 is hydraulically driven by the first pump device 101 to switch between the engaged state and the disengaged state thereof. As shown in FIG. 2, the clutch device 104 includes a clutch device body 200, which includes a driving assembly 201 and a driven assembly 202. The driving assembly 201 is connected to the driving device shaft 131 (see FIG. 1) of the driving device 103 via the driving engagement portion 132, and the driven assembly 202 is connected to the second pump device 102 (see FIG. 1) via the driven engagement portion 133. In an embodiment, the driving engagement portion 132 and the driven engagement portion 133 are shafts. In other embodiments, the driving engagement portion 132 and the driven engagement portion 133 include other suitable structures. The clutch device 104 further includes a fluid chamber 203 for receiving the fluid conveyed from the first pump device 101 (see FIG. 1). The fluid chamber 203 is connected to the clutch device body 200 for transferring the fluid pressure generated by the flowing fluid to the clutch device body 200. The clutch device body 200 is configured to switch to the engaged state on the basis of the fluid pressure to engage the driving assembly 201 with the driven assembly 202, to connect the driving device 103 to the second pump device 102 to drive the second pump device 102. When the fluid chamber 203 does not receive the fluid conveyed from the first pump device 101, no fluid pressure is generated and transferred to the clutch device body 200. In this case, the clutch device body 200 remains in the disengaged state, i.e., the driving assembly 201 and the driven assembly 202 remain disengaged. The driving device 103 is therefore disconnected from the second pump device 102 and cannot drive the second pump device 102.

More specifically, the operation of the driving device 103 is controlled by the controller 127 to rotate the driving device shaft 131 (see FIG. 1). When the clutch device 104 is switched to the engaged state when the fluid chamber 203 receives the fluid conveyed from the first pump device 101, the rotating driving device shaft 131 in turn drives the driving engagement portion 132, the driving assembly 201, the driven assembly 202 and the driven engagement portion 133 of the clutch device 104 to move, and the driven engagement portion 133 in turn drives the second pump device 102 to operate, so that the fluid can be conveyed from the first thermal management valve device 105 to the second thermal management valve device 106 through the second flow channel 116, 117 (see FIG. 1). When the clutch device 104 does not receive the fluid conveyed from the first pump device 101 and retains in the disengaged state, the driving assembly 201 cannot drive the driven assembly 202 to move, and the driven assembly 202 cannot drive the second pump device 102 to operate, so that the operation of the second pump device 102 cannot be driven by the driving device 103. The second flow channel 116, 117 is therefore not used to convey the fluid from the first thermal management valve device 105 to the second thermal management valve device 106.

In an embodiment, the clutch device 104 is in the disengaged state by default. When the clutch device 104 is activated, for example, by means of electrical power, a mechanical device, hydraulic means and so on, the clutch device 104 is switched from the disengaged state to the engaged state. In other embodiments, the clutch device 104 is switched between the disengaged state and the engaged state by other suitable means.

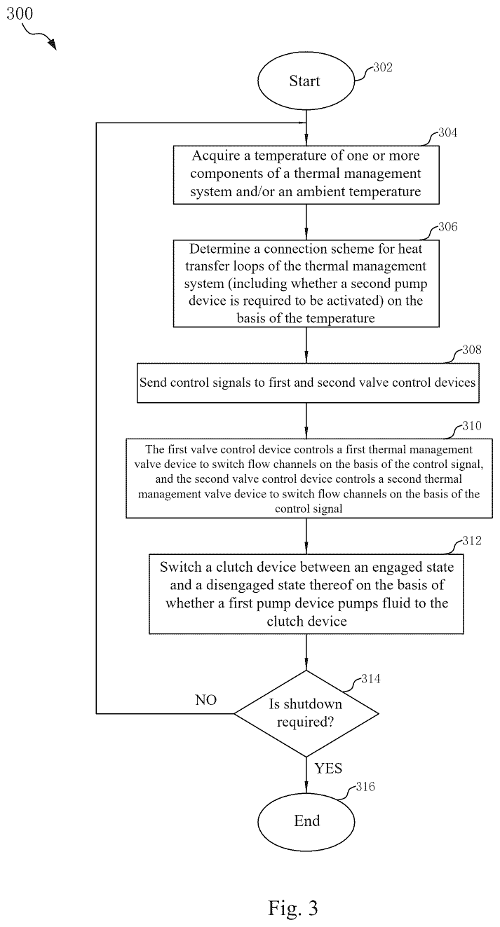

FIG. 3 shows a block diagram of a thermal management method 300 for a thermal management system according to an embodiment of the present disclosure.

As shown in FIG. 3, the thermal management method 300 starts at step 302 and then proceeds from step 302 to step 304.

In step 304, a temperature of one or more components (e.g., a cabin, a power train (PT), a battery, etc.) of a thermal management system 100 and/or an ambient temperature is acquired. The method then proceeds from step 304 to step 306.

In step 306, a connection scheme, such as a fluid flow path, for heat transfer loops of the thermal management system 100 is determined on the basis of the temperature of one or more components of the thermal management system 100 and/or the ambient temperature. The connection scheme includes whether a second pump device 102 is required to be activated to selectively convey fluid from a first thermal management valve device 105 to a second thermal management valve device 106 through a second flow channel 116, 117. Then, the method proceeds from step 306 to step 308. In an embodiment, on the basis of the temperature of one or more components of the thermal management system 100 and/or the ambient temperature, the connection scheme for the heat transfer loops of the thermal management system 100 is determined by determining the parallel or series connection of the heat transfer loops of the thermal management system 100 and the required flow rate, or by determining the components of the thermal management system 100 that are required to be heated or cooled.

In step 308, control signals are sent to a first valve control device 125 and a second valve control device 126 on the basis of the determined connection scheme for the heat transfer loops. The method then proceeds from step 308 to step 310. In an embodiment, the above steps 304, 306, and 308 are performed by a controller 127.

In step 310, the first valve control device 125 controls the first thermal management valve device 105 to switch flow channels on the basis of the received control signal, and the second valve control device 126 controls the second thermal management valve device 106 to switch flow channels on the basis of the received control signal. When the first thermal management valve device 105 controls a clutch device 104 to activate the second pump device 102, the second thermal management valve device 106 has its flow channels configured such that a valve outlet 154 is always open, so that the fluid is pumped by a first pump device 101 to the first thermal management valve device 105 through the second thermal management valve device 106 and a fourth flow channel 151. Moreover, the first thermal management valve device 105 switches the flow channels to open a valve outlet 156 so that the fluid pumped by the first pump device 101 is conveyed to the clutch device 104 through the first thermal management valve device 105 and a fifth flow channel 152. When the first thermal management valve device 105 does not control the clutch device 104 to activate the second pump device 102, the first thermal management valve device 105 switches the flow channels to close the valve outlet 156, so that the fluid is not pumped by the first pump device 101 to the clutch device 104 through the first thermal management valve device 105 and the fifth flow channel 152. Moreover, the first valve control device 125 controls, on the basis of the received control signal, the first thermal management valve device 105 to switch the flow channels to cause the fluid from one or more components of the thermal management system 100 to flow to a required flow channel, such as a first flow channel 114 and/or a second flow channel 116, through the first thermal management valve device 105. The control further includes controlling the opening degree of the selected flow channel of the first thermal management valve device 105 to control the flow rate of the fluid.

In step 310, when the second thermal management valve device 106 controls the clutch device 104 to activate the second pump device 102, the second thermal management valve device 106 switches the flow channels to open a valve outlet 123, so that the fluid is not pumped by the first pump device 101 to the clutch device 104 through the second thermal management valve device 106 and a third flow channel 122. When the second thermal management valve device 106 does not control the clutch device 104 to activate the second pump device 102, the second thermal management valve device 106 switches the flow channels to close the valve outlet 123, so that the fluid is not pumped by the first pump device 101 to the clutch device 104 through the second thermal management valve device 106 and the third flow channel 122. Moreover, the second valve control device 126 controls, on the basis of the received control signal, the second thermal management valve device 106 to switch the flow channels to cause the fluid, for example from the first flow channel 114 and/or the second flow channel 116, to flow through the second thermal management valve device 106 to one or more components of the thermal management system 100 where the fluid is required to arrive. The control further includes controlling the opening degree of the selected flow channel of the second thermal management valve device 106 to control the flow rate of the fluid. Then, the method proceeds from step 310 to step 312.

In step 312, the clutch device 104 is switched between the engaged state and the disengaged state thereof on the basis of whether the first pump device 101 pumps the fluid to the clutch device 104 through the second thermal management valve device 106 and the third flow channel 122, to connect or disconnect a driving device 103 and the second pump device 102, thereby selectively activating the second pump device 102. When the second pump device 102 is activated, the fluid is conveyed from the first thermal management valve device 105 to the second thermal management valve device 106 through the second flow channel 116, 117. When the second pump device 102 is not activated, the fluid is not conveyed from the first thermal management valve device 105 to the second thermal management valve device 106 through the second flow channel 116, 117. The fluid flows in each flow channel on the basis of the determined connection scheme for the heat transfer loops, to cool or heat the required components to bring these components to the required temperatures. Then, the method proceeds from step 312 to step 314.

Optionally, in steps 310 and 312, the above operation also applies to the control over an additional clutch device 141 (see FIG. 1) by the first thermal management valve device 105 and the second thermal management valve device 106. For example, the second valve control device 126 controls a flow channel of the second thermal management valve device 106 to communicate with the fourth flow channel 151 on the basis of the received control signal, and the first valve control device 125 controls the first thermal management valve device 105 to switch the flow channels on the basis of the received control signal, to switch the additional clutch device 141 between the engaged state and the disengaged state thereof, to selectively activate the additional pump device 142, thereby selectively conveying the fluid from the first thermal management valve device 105 to the second thermal management valve device 106 through an additional flow channel 146, 147. The second valve control device 126 controls the second thermal management valve device 106 to switch the flow channels on the basis of the received control signal, to switch the additional clutch device 141 between the engaged state and the disengaged state thereof, to selectively activate the additional pump device 142, thereby selectively conveying the fluid from the first thermal management valve device 105 to the second thermal management valve device 106 through the additional flow channel 146, 147.

In step 314, it is determined whether the vehicle is required to be shut down. If the vehicle is required to be shut down, the method proceeds from step 314 to step 316. If the vehicle is not required to be shut down, the method proceeds from step 314 to step 304.

In step 316, execution of the thermal management method 300 ends.

Although the present disclosure is described in conjunction with the examples of embodiments outlined above, various alternatives, modifications, variations, improvements, and/or substantial equivalents that are known or current or to be anticipated before long may be obvious to those of at least ordinary skill in the art. Furthermore, the technical effects and/or technical problems described in this description are exemplary rather than limiting; therefore, the disclosure in this description may be used to solve other technical problems and have other technical effects and/or may solve other technical problems. Accordingly, the examples of the embodiments of the present disclosure as set forth above are intended to be illustrative rather than limiting. Various changes may be made without departing from the spirit or scope of the present disclosure. Therefore, the present disclosure is intended to embrace all known or earlier disclosed alternatives, modifications, variations, improvements, and/or substantial equivalents.

What is claimed is:

1. A thermal management system for a vehicle, the thermal management system comprising:
a first flow channel;
a second flow channel;
a first pump device fluidly connected to the first flow channel;
a second pump device fluidly connected to the second flow channel;
a single driving device connected to the first pump device to drive the first pump device; and
a clutch device connected between the driving device and the second pump device and configured to connect or disconnect the driving device and the second pump device, to selectively allow the driving device to drive the second pump device.

2. The thermal management system according to claim 1, wherein
the single driving device comprises a single motor.

3. The thermal management system according to claim 1, further comprising:
a first thermal management valve device; and
a second thermal management valve device,
wherein the first flow channel fluidly connects the first thermal management valve device to the second thermal management valve device, and the second flow channel fluidly connects the first thermal management valve device to the second thermal management valve device; and
the clutch device is configured to selectively allow the driving device to drive the second pump device to selectively convey a fluid from the first thermal management valve device to the second thermal management valve device through the second flow channel.

4. The thermal management system according to claim 1, wherein
the clutch device is configured to connect the driving device to the second pump device on the basis of temperature of one or more components of the thermal management system and/or an ambient temperature.

5. The thermal management system according to claim 1, wherein
the clutch device is configured to switch between an engaged state and a disengaged state thereof according to whether the first pump device pumps the fluid to the clutch device, to connect or disconnect the driving device and the second pump device.

6. The thermal management system according to claim 5, wherein
the first thermal management valve device and the second thermal management valve device are respectively a first manifold valve and a second manifold valve.

7. The thermal management system according to claim 6, further comprising:
a third flow channel connected between the second thermal management valve device and the clutch device to convey the fluid that is to be pumped by the first pump device to the clutch device.

8. The thermal management system according to claim 7, wherein
the second manifold valve is configured to control, by switching flow channels thereof, whether the fluid pumped by the first pump device to the second manifold valve is conveyed to the clutch device.

9. The thermal management system according to claim 8, further comprising:
a fourth flow channel connected between the first thermal management valve device and the second thermal management valve device to convey the fluid that is to be pumped by the first pump device to the clutch device; and
a fifth flow channel connected between the first thermal management valve device and the clutch device to convey the fluid that is to be pumped by the first pump device to the clutch device.

10. The thermal management system according to claim 9, wherein
the second manifold valve is configured to convey the fluid, which is pumped by the first pump device to the second manifold valve, to the first manifold valve through a flow channel of the second manifold valve; and
the first manifold valve is configured to control, by switching flow channels thereof, whether the fluid pumped by the first pump device to the first manifold valve is conveyed to the clutch device.

11. The thermal management system according to claim 10, wherein
the first manifold valve and the second manifold valve are each configured to control, by switching the flow channels thereof, whether the fluid pumped by the first pump device is conveyed to the clutch device, to control the clutch device to switch between the engaged state and the disengaged state thereof, thereby connecting or disconnecting the driving device and the second pump device.

12. The thermal management system according to claim 1, wherein the thermal management system is operated in pump device operating modes as follows:
a first pump device operating mode in which only the first pump device is activated; and
a second pump device operating mode in which the first pump device and the second pump device are activated.

13. The thermal management system according to claim 1, wherein
the first pump device is a main pump device configured to allow the fluid to flow at a high flow rate; and
the second pump device is an auxiliary pump device configured as a supplement to the main pump device.

14. The thermal management system according to claim 1, wherein
the first flow channel and the second flow channel are each a part of a cooling circuit or a heating circuit in the thermal management system.

15. The thermal management system according to claim 3, further comprising:
an additional flow channel fluidly connecting the first thermal management valve device to the second thermal management valve device;
an additional pump device; and
an additional clutch device connected between the driving device and the additional pump device and configured to connect or disconnect the driving device and the additional pump device to selectively allow the driving device to drive the additional pump device, to selectively convey the fluid from the first thermal management valve device to the second thermal management valve device through the additional flow channel.

16. The thermal management system according to claim 15, wherein
the first thermal management valve device and the second thermal management valve device are each configured to control, by switching flow channels thereof, whether the fluid pumped by the first pump device is conveyed to the additional clutch device, to control the additional clutch device to switch between an engaged state and a disengaged state thereof, thereby connecting or disconnecting the driving device and the additional pump device.
